(19) United States
(12) Patent Application Publication
(10) Pub. No.: US 2026/0241892 A1
(43) Pub. Date: Aug. 20, 2026

(54) Arrangement and Method

(71) Applicant: Bayerische Motoren Werke Aktiengesellschaft, Muenchen (DE)

(72) Inventors: Martin KUGLER, Vierkirchen (DE); Christian LEMKEMEYER, Muenchen (DE)

(21) Appl. No.: 19/542,824

(22) Filed: Feb. 18, 2026

(30) Foreign Application Priority Data
Feb. 19, 2025 (DE) 10 2025 106 204.8

(51) Int. Cl. B60R 25/40; B60R 25/01; B60R 25/24; G07C 9/00; G07C 9/22; H02J 50/10

(52) U.S. Cl. CPC B60R 25/406; B60R 25/01; B60R 25/24; G07C 9/00309; G07C 9/22; H02J 50/10; B60R 2325/205; G07C 2009/00611; G07C 2009/00793

(57) ABSTRACT

An arrangement for wireless energy transmission and/or authentication between a vehicle and a mobile device is provided. The arrangement includes the vehicle, an energy transfer apparatus, which is arranged in or on the vehicle and is designed to carry out inductive energy transmission with the mobile device. The energy transfer apparatus has a data interface apparatus for wireless communication, which is designed to transmit a charging protocol between the energy transfer apparatus and the mobile device, and to transfer a digital key for uniquely authenticating the vehicle and/or the mobile device. A control and/or evaluation apparatus is designed, after successful authentication by the digital key to at least enable energy transmission between the vehicle and the mobile device, and/or enable at least one vehicle function. A corresponding method is also provided.

### CROSS REFERENCE TO RELATED APPLICATION

This application claims priority under 35 U.S.C. § 119 from German Patent Application No. 10 2025 106 204.8, filed Feb. 19, 2025, the entire disclosure of which is herein expressly incorporated by reference.

### BACKGROUND AND SUMMARY

The present invention relates to an arrangement and to a method for wireless energy transmission and/or authentication between a vehicle and a mobile device.

The progressive digitization and the increasing integration of mobile devices into everyday life have led to an increasing demand for efficient and user-friendly charging solutions. In particular in the context of vehicles, be it in the private passenger car sector, in commercial vehicles or autonomous vehicles, wireless energy transmission and/or wireless control of vehicle functions is gaining in importance. Traditional wired systems often reach their limits here because they are awkward to handle and may compromise the esthetics and convenience of vehicle use.

An object of the present invention can be seen as that of providing an improved arrangement and an improved method for energy transmission and/or authentication between a vehicle and a mobile device.

This object is achieved by an arrangement and by a method having the features of the independent claims.

According to the invention, the following is provided:

An arrangement for wireless energy transmission and authentication between a vehicle and a mobile device, comprising the vehicle, an energy transfer apparatus, which is arranged in or on the vehicle and is designed to carry out inductive energy transmission with the mobile device, wherein the energy transfer apparatus has a data interface apparatus for wireless communication, which is designed: to transmit a charging protocol between the energy transfer apparatus and the mobile device, and to transfer a digital key for uniquely authenticating the vehicle and/or the mobile device; and a control and/or evaluation apparatus, which is designed, after successful authentication by means of the digital key, to at least: enable energy transmission between the vehicle and the mobile device, and/or enable at least one vehicle function.

A method for wireless energy transmission and authentication between a vehicle and a mobile device, using an energy transfer apparatus, which has a data interface apparatus for wireless communication, and is connected to a control and/or evaluation apparatus, is furthermore provided, comprising the following steps: providing the vehicle and arranging the energy transfer apparatus in or on the vehicle, activating the data interface apparatus, which is designed to exchange a charging protocol with the mobile device, establishing inductive energy transmission and/or data transmission between the energy transfer apparatus and the mobile device, transferring a digital key between the vehicle and the mobile device via the data interface apparatus, authenticating the vehicle and/or the mobile device with the aid of the digital key, and enabling energy transmission between the vehicle and the mobile device, and/or at least one vehicle function by means of the control and/or evaluation apparatus after successful authentication.

The embodiment described relates to an arrangement that allows wireless energy transmission and/or authentication between a vehicle and a mobile device. A central feature is the vehicle itself, which serves as a platform for the energy transfer apparatus and the further components. The vehicle may comprise various types, such as a passenger car, a commercial vehicle, a motorcycle or an autonomous vehicle, wherein the specific vehicle type may influence the technical configuration.

The energy transfer apparatus is arranged in or on the vehicle and is designed in such a way that it is able to carry out inductive energy transmission with the mobile device. By way of example, the energy transfer apparatus may be designed as a charging surface or tray inside the vehicle, on which the mobile device may be positioned for wireless energy transmission. Alternatively, the apparatus could also be integrated on the outside of the vehicle to ensure flexible use. Induction is typically carried out by coupled coils in the energy transfer apparatus and in the mobile device, which use an electromagnetic field to wirelessly transmit electrical energy.

An essential element of this energy transfer apparatus is the data interface apparatus, which is configured for wireless communication between the vehicle and the mobile device. The data interface apparatus is able to transmit a charging protocol, which allows the charging process to be controlled and monitored. In addition, the data interface apparatus is used to transfer a digital key that allows the authentication of the vehicle and/or of the mobile device. The data interface apparatus may be based on various wireless communication standards.

The control and/or evaluation apparatus represents a further central component of the arrangement. The control and/or evaluation apparatus is responsible for controlling and enabling the energy transmission between the vehicle and the mobile device. Said energy transmission is enabled only after successful authentication by means of the digital key. This authentication ensures that only authorized devices may draw energy from the vehicle or vice versa. The control and/or evaluation apparatus may also perform further functions, such as optimizing the charging parameters or identifying interference during energy transmission.

One possible technical configuration of the energy transfer apparatus could be an integration of multi-coil arrangements to minimize the positioning requirements of the mobile device. The data interface apparatus could additionally be secured by encryption technologies such as TLS and/or AES to ensure the security of the transmitted information, in particular of the digital key. The control and/or evaluation apparatus could be enhanced with software updates to support future protocols or standards.

The features described offer a plurality of technical advantages. Wireless energy transmission increases user convenience, since cables may be dispensed with, and improves the esthetics and functionality in the vehicle. Authentication using a digital key increases security, since unauthorized devices are not able to draw energy, and additional functions, such as unlocking the vehicle and/or starting the engine, are only able to be activated by authorized devices. The flexible technical configuration of the data interface apparatus and control allows broad application and easy adaptation to future technological developments. This makes the arrangement a future-proof and user-friendly solution for wireless charging and secure authentication.

The digital key is a central component of the arrangement and is used for secure authentication between a vehicle and a mobile device. The digital key apparatus represents the technical platform that stores the digital key. The digital key and the digital key apparatus are designed in accordance with the specifications of version 3.0 or higher of the Car Connectivity Consortium (CCC) to ensure seamless and standardized integration into modern vehicles and mobile devices.

The digital key allows access to the vehicle and/or the use of certain functions of the vehicle, such as bidirectional energy transmission between the vehicle and the mobile device and/or unlocking the door and/or starting the engine.

The digital key is transmitted wirelessly via the data interface apparatus of the energy transfer apparatus. After successful authentication by the control and/or evaluation apparatus, specific vehicle functions of the vehicle are enabled. This includes enabling energy transmission in which the vehicle and the mobile device may alternately act as an energy source and/or energy sink, depending on the energy requirement and the state of charge of both systems.

The digital key apparatus is designed to support future enhancements. By way of example, additional security features such as biometric authentication, in particular such as fingerprint or face recognition, for example, may be integrated, and the digital key may be adapted to new CCC specifications or security standards by way of regular software updates. This ensures long-term interoperability and security of the entire system.

The standardized design in accordance with CCC specifications 3.0 or higher achieves a high compatibility between different vehicle manufacturers and mobile devices. This allows flexible use of the arrangement and ensures that both existing and future requirements in respect of security, ease of use and functionality are met.

According to a preferred embodiment, the charging protocol may correspond to a Qi standard, in particular the Qi2 standard or higher, and the charging control and the transmission of the digital key may be carried out via the same data channel.

The embodiment described specifies that the charging protocol of the energy transfer apparatus may correspond to a Qi standard, wherein in particular the Qi2 standard is preferred. The Qi standard is an internationally recognized standard for wireless energy transmission by means of electromagnetic induction, which ensures high compatibility and interoperability between different devices. The Qi2 standard represents a development that offers improved efficiency, increased charging speed and enhanced security features.

An outstanding feature of this embodiment is that both the charging control and the transmission of the digital key may be carried out via the same data channel. This means that the data interface apparatus of the energy transfer apparatus is used not only for controlling the inductive charging process, but also for authenticating the vehicle and/or the mobile device. The common data channel reduces the need for additional communication interfaces, which may reduce the technical complexity and the costs of the arrangement.

The functionality of this embodiment is based on bidirectional communication via the data channel, in which the charging protocol transmits information about the present state of charge, the remaining charging time or fault states. At the same time, the digital key that is required for the authentication is securely transmitted. By way of example, this could be secured by cryptographic methods such as AES encryption or a secure key exchange (for example by means of TLS) to prevent unauthorized access.

Technically, this embodiment could be implemented by the integration of a communication chip that supports both the Qi charging communication and the authentication. The implementation could comprise extended functions such as real-time adaptations of the charging parameters on the basis of the authentication data. In addition, the common data channel could be organized by time-division multiplexing to further optimize the efficiency of the data transmission.

This embodiment offers a plurality of technical advantages. By using the Qi2 standard, compatibility problems are reduced, with the result that a wide range of mobile devices are able to be used. The use of a common data channel simplifies the design of the energy transfer apparatus and saves on space, which is particularly advantageous in vehicles with limited installation space. Furthermore, security is increased, since the digital key is transmitted via a standardized, secure connection that makes manipulation or eavesdropping attempts difficult. Overall, this embodiment contributes to a more efficient, secure, and user-friendly wireless arrangement.

According to a further preferred embodiment, the authentication may comprise a CCC Digital Key as a digital key, which is designed in accordance with a standardized vehicle access and/or engine starting method.

The described embodiment makes provision for the authentication to be able to be carried out by a CCC Digital Key as a digital key. The CCC Digital Key is a standard developed by the Car Connectivity Consortium (CCC) that enables secure digital authentication between a vehicle and a mobile device. This standard is supported globally by numerous vehicle and device manufacturers, which ensures high interoperability and compatibility.

The digital key may be designed in accordance with a standardized vehicle access and/or engine starting method. This means that the CCC Digital Key may be used not only for energy transmission, but also for security-critical functions such as unlocking the vehicle or starting the engine. A typical example would be the use of a smartphone as a digital vehicle key.

The method of operation of this embodiment is based on a secure identification of the mobile device with respect to the vehicle. The digital key contains encrypted authentication information that may only be decrypted and validated by the control and/or evaluation apparatus of the vehicle. After successful authentication, the vehicle may enable energy transmission and optionally activate additional functions such as unlocking the doors or starting the engine.

Technically, the digital key could be protected by cryptography methods such as elliptic curves or public key infrastructures (PKI). One implementation could also comprise mechanisms such as a two-factor authentication for which an additional security check, for example a biometric feature or a PIN, is required in addition to the digital key. The digital key could also be stored in a secure hardware component of the mobile device, for instance in a trusted execution environment (TEE) or a secure element chip.

The embodiment offers a plurality of technical advantages. The use of a standardized digital key such as the CCC Digital Key ensures a high level of security, since the key is designed to be manipulation-proof and copy-proof. Furthermore, standardization simplifies the integration into existing vehicle and device technologies, as a result of which development efforts and costs are reduced. The possibility of using the digital key for a plurality of functions, from energy transmission to vehicle access, increases the ease of use and flexibility of the solution. This embodiment therefore significantly contributes to the security and convenience in the application by providing a modern, interoperable and secure authentication method.

According to a further preferred embodiment, the energy transfer apparatus may be formed inside the vehicle as a charging tray in which the mobile device is able to be arranged simultaneously for the authentication by means of the digital key and the charging process.

The embodiment described shows that the energy transfer apparatus may be formed inside the vehicle as a charging tray. This charging tray is used as a physical placeholder and interface on which the mobile device may be positioned to simultaneously perform both the authentication by means of the digital key and the charging process. Combining both functions in a single apparatus optimizes the ease of use and reduces the technical complexity.

The charging tray may be designed in such a way that it securely holds the mobile device and simultaneously ensures optimal positioning for wireless energy transmission. This could be implemented using anti-slip surfaces, magnetic mounts, or mechanical fixtures to ensure that the device remains in place even while driving. The charging tray could be integrated ergonomically in the center console, on the armrest or in the vicinity of the driver's seat position so as to ensure easy accessibility.

The energy transfer apparatus inside the charging tray could consist of one or more induction coils that are strategically arranged so as to ensure energy transmission regardless of the exact position of the device. This could be carried out using multi-coil technologies or one large, extensive coil. Furthermore, the charging tray could have integrated cooling to dissipate the heat generated during charging and increase the efficiency of the charging process.

The authentication by means of the digital key is carried out in parallel with the charging process via the data interface apparatus, which is also integrated into the charging tray. The communication could take place in particular by means of a Qi2 standard or higher, for example a Qi3 standard, in particular in a similar manner to the Magnetic Power Profile (MPP) and/or Extended Power Profile (EPP).

The Magnetic Power Profile (MPP) is a technical standard that is used as part of the Qi charging standard for optimizing wireless energy transmission. It defines the parameters and protocols that allow precise and efficient energy transmission between the charging device and the mobile terminal. The MPP is based on the use of magnetic induction, in which energy is transmitted between two electromagnetic coils—a transmitting coil and a receiving coil. In order to maximize charging efficiency, the MPP continuously monitors the coupling between the coils and dynamically adapts the transmission power to the specific requirements of the mobile device. Critical functions of the MPP include the ability to communicate states of charge in real time, to detect potential interference in the electromagnetic environment, and to minimize this by adapting the frequency or power. This optimization reduces energy losses and the generation of heat, which is particularly advantageous in enclosed environments such as vehicles. The MPP is predominantly used in standard charging scenarios in which moderate charging powers are required.

The Extended Power Profile (EPP) extends the functionalities of the Magnetic Power Profile and is specifically configured for the transmission of higher charging powers. It is intended for devices that require larger amounts of energy, such as powerful smartphones, tablets or laptops. The EPP integrates advanced control protocols to securely and efficiently provide charging powers of up to 15 watts or more while simultaneously ensuring the system stability and security. A central feature of the EPP is the enhanced security architecture, which comprises mechanisms for temperature monitoring, overload protection, and precise positioning. Furthermore, the EPP offers an enhanced communication capability between the charging device and the terminal, which makes it possible to incorporate additional parameters such as charging preferences, battery temperature and usage priorities, for example, into the control. The EPP is particularly suitable in scenarios in which a fast charging process is required without compromising the life of the battery or security. The combination of high efficiency, security and flexibility makes the EPP an essential component of modern, high-performance, wireless arrangements and methods.

One possible technical design could be that the charging tray contains sensors that detect when a compatible mobile device is inserted so as to automatically start the authentication and charging process.

This embodiment offers a plurality of technical and practical advantages. Integrating authentication and a charging process in a charging tray reduces the need for separate components, thereby making efficient use of the installation space in the vehicle. Performing both processes simultaneously saves on time and increases the convenience for the user, since there is no need for any additional interactions. In addition, security is increased, since the charging tray is specifically configured for authorized devices, which further restricts access to the functions of the vehicle. Ergonomic placement and ease of handling contribute to the ease of use, while the technical configurations ensure efficient and reliable functionality.

According to a further preferred embodiment, a further wireless charging point may be arranged outside of the vehicle, said charging point being able to be designed to allow external energization via the mobile device when the vehicle battery is discharged, wherein an authentication for enabling vehicle access may be simultaneously carried out.

The embodiment described makes provision for a further wireless charging point to be able to be arranged outside of the vehicle. This charging point is configured such that it is not only used for wireless energy transmission, but it also allows what is known as external energization, in which the mobile device is able to deliver energy to the vehicle or the vehicle is able to deliver energy to the mobile device. This is particularly useful in situations in which the vehicle battery is discharged, since the mobile device is able to provide an emergency power supply. Simultaneously, authentication of the mobile device may be carried out via the charging point in order to enable vehicle access.

Technically, this charging point could be positioned, for example, on the outside of the vehicle, for instance in the vicinity of the door handles, the hood and/or at the rear. This ensures easy accessibility, in particular in emergency situations. The charging point could be protected by robust materials to be resistant to the weather, dirt and mechanical loads. One possible design would be a flap or cover that protects the charging point when not in use.

External energization via the mobile device requires a bidirectional energy transmission capability, in which the mobile device is able to act both as an energy receiver and an energy source. The technology necessary for this could be implemented by a reversible induction coil at the charging point, which is able to both receive and deliver energy. The charging point could additionally be equipped with electronics that monitor and control the flow of energy to prevent overloading of the mobile device.

The authentication for enabling vehicle access takes place in parallel with the energy transmission and is made possible by the digital key of the mobile device. In this case, wireless data communication, in particular in accordance with the Qi2 standard or higher, for example a Qi3 standard, could preferably take place via the Magnetic Power Profile (MPP) and/or Extended Power Profile (EPP).

This embodiment offers a plurality of technical advantages. The external charging point allows emergency power to be supplied to the vehicle in situations in which the main battery is discharged, and is thus able to increase the operational readiness of the vehicle. Combining energy transmission and authentication ensures security, since access to the vehicle is enabled only if authentication is successful. Positioning the charging point outside of the vehicle increases ease of use, in particular in emergency situations or in situations in which the vehicle is locked. Furthermore, the possibility of transmitting power in a bidirectional manner contributes to a more versatile use of the mobile device, which increases its value and functionality for the user.

According to a further preferred embodiment, the data interface apparatus and the control and/or evaluation apparatus may be connected to one other in such a way that, in the case of successful authentication by means of the digital key, at least one function of the vehicle may be enabled, in particular selected from unlocking the door, starting the engine or enabling energy transmission.

The embodiment described makes provision for the data interface apparatus and the control and/or evaluation apparatus to be able to be connected to one another in such a way that, after successful authentication by means of the digital key, at least one function of the vehicle may be enabled. The possible enabled functions include, in particular, unlocking the door, starting the engine or enabling energy transmission. This enables secure and user-friendly control of central vehicle functions by an authorized mobile device.

In this embodiment, the data interface apparatus performs the task of forwarding the authentication data of the digital key from the mobile device to the control and/or evaluation apparatus. The control and/or evaluation apparatus analyzes this data and checks the validity of the key. After successful authentication, a corresponding signal is sent to the respective subsystems of the vehicle in order to enable the desired function.

Technically, the data interface apparatus and the control and/or evaluation apparatus could be connected via a secure communication protocol, which ensures an encrypted data transmission. The control and/or evaluation apparatus could additionally be programmable to flexibly configure the enabled functions depending on user requirements or security levels.

Unlocking the door as a possible function could be implemented, for example, by an electrical locking system, which is activated by way of a signal from the control and/or evaluation apparatus. The engine could be started by enabling the ignition system, wherein additional security mechanisms such as a start PIN or double authentication could be integrated. In contrast, enabling energy transmission could consist of the energy transfer apparatus transmitting energy to the mobile device or receiving energy only after successful authentication.

This embodiment offers considerable technical advantages. Linking authentication and vehicle functions increases security, since unauthorized users do not have access to the enabled functions. At the same time, the convenience for authorized users is significantly increased, since important vehicle functions are able to be controlled directly via a mobile device. The flexibility of the control and/or evaluation apparatus additionally enables easy adaptation to future requirements, for instance by way of software updates or the integration of new functions. The configuration described achieves a secure, efficient and user-friendly interaction between the vehicle and the mobile device.

According to a further preferred embodiment, the data interface apparatus may be configured for real-time evaluation of the authentication data sent by the mobile device and designed to enable and/or adapt the subsequent charging process depending on the result of the authentication.

The embodiment described makes provision for the data interface apparatus to be able to be configured for real-time evaluation of the authentication data sent by the mobile device. This function allows immediate analysis of the information provided by the mobile device in order to make a quick and reliable decision about permission to use the arrangement. Depending on the result of this real-time evaluation, the subsequent charging process may be enabled and/or dynamically adapted.

The data interface apparatus could be technically configured in such a way that it in particular provides at least partially continuous communication with the mobile device. This could be carried out by using communication standards such as the Qi standard, in particular the Qi2 standard, preferably in the course of the transmission of the Magnetic Power Profile (MPP) and/or the Extended Power Profile (EPP).

For the authentication check, the data in the data interface apparatus could be first stored temporarily and then forwarded to the control and/or evaluation apparatus. The control and/or evaluation apparatus checks the validity of the authentication data, such as the digital key, by comparing them with stored key information.

In the event of successful authentication, the charging process may be enabled, wherein the data interface apparatus automatically transfers the necessary control commands to the energy transfer apparatus. The adaptation of the charging process could consist of varying the charging power depending on the parameters of the mobile device, such as its rechargeable battery level, charging preferences or heat generation. These adaptations could be made, for example, via variable regulation of the induction coils, which is controlled by the data interface apparatus.

The data interface apparatus could continue to be protected by security mechanisms such as encryption or authentication protocols to ensure that the transferred data is not able to be intercepted or manipulated by unauthorized parties. One possible configuration could additionally make provision for the charging process to be completely blocked in the event of a failed authentication, whereas an optimized charging procedure is started in the event of a successful authentication.

This embodiment offers a plurality of technical advantages. The possibility of evaluating the authentication data in real time considerably improves security, since unauthorized devices are able to be immediately detected and eliminated. In addition, the dynamic adaptation of the charging process increases the efficiency and the service life of the systems involved, since the charging process is able to be adapted to the specific requirements of the mobile device. Furthermore, real-time analysis also enables seamless and user-friendly use, since the entire process runs automatically and without delay. Overall, this embodiment contributes to secure, efficient and convenient energy transmission.

According to a further preferred embodiment, an optimized geometric arrangement of antenna structures in the vehicle may be made possible by integrating the wireless charging and authentication functions in the energy transfer apparatus, with the result that interference between these functions may in particular be reduced.

The described embodiment makes provision for an optimized geometric arrangement of antenna structures in the vehicle to be made possible by integrating the wireless charging and authentication functions in the energy transfer apparatus. This combination in a single apparatus contributes to minimizing space requirements in the vehicle and increasing the efficiency and the reliability of wireless energy transmission and authentication.

The antenna structures, which are able to be used both for energy transmission and for wireless communication for the authentication, could be arranged in such a way that mutual interference is reduced. One technical implementation could consist of the antennas for inductive energy transmission and those for wireless data communication operating on different frequency bands and being spatially positioned in such a way that an overlap of their electromagnetic fields is minimized. Alternatively a frequency and/or time-division multiplexing method could be used to ensure a harmonized coexistence of the functions.

One possible design of the antenna structures could comprise flat coils for energy transmission, which are integrated into the charging surface and are flanked by smaller communication antennas for the authentication. This spatial separation and the adaptation of the transmission strength could reduce the susceptibility to interference between the two functions. In addition, a metallic shield or a specific material choice could limit the propagation of unwanted electromagnetic radiation.

The integration of the two functions in a single energy transfer apparatus offers not only space-saving advantages, but also technical efficiency. The charging and authentication functions share hardware resources such as control and processing logic, as a result of which outlay on materials and manufacturing costs may be reduced. This integration could also facilitate calibration and alignment between the two functions, since they are coordinated by a central control unit.

Technical advantages of this embodiment are the reduction of interference, which results in more stable energy transmission and more reliable authentication. At the same time, the optimized arrangement of the antennas makes efficient use of the installation space, which is particularly advantageous in vehicles with limited available space. The integration of the functions additionally simplifies the system architecture and allows easier installation and maintenance. This combination of advantages makes the embodiment described an efficient and technically advanced solution for wireless charging and authentication applications in the vehicle.

According to a further preferred embodiment, when the rechargeable battery of the mobile device is empty, authentication may be made possible by the energy transfer apparatus using a minimum residual energy supply, in particular to ensure that the engine is started inside the vehicle.

The embodiment described makes provision, when the rechargeable battery of the mobile device is empty, for authentication to be made possible by the energy transfer apparatus using a minimum residual energy supply. This function ensures that important vehicle functions, such as starting the engine, are able to be activated even in situations in which the mobile device is almost completely discharged. This is particularly relevant if the mobile device is the only digital key for accessing and starting the vehicle.

The energy transfer apparatus could be designed in such a way that it is able to provide a minimum amount of energy to put the mobile device in a ready state. By way of example, this could be achieved by a specific emergency energy transmission function that only generates a low output power that is sufficient to activate the mobile device for the authentication. Technically, this could be carried out by a fast energy transmission based on a high frequency signal or by providing a pulsed energy supply that efficiently wakes up the device.

The minimum required energy supply could be regulated by intelligent sensors in the energy transfer apparatus, which detect that the mobile device is connected but does not have a sufficient charging status. After the activation of the mobile device, the authentication could be carried out via the data interface apparatus, wherein the digital key is read out and compared with the stored vehicle data. Only after successful authentication would the control and/or evaluation apparatus enable the starting of the engine.

One technical implementation could also make provision for the energy transfer apparatus to have a separate energy storage unit, which is specifically reserved for emergencies. By way of example, this energy storage unit could consist of a small, integrated battery or a supercapacitor that is ready to supply energy to the mobile device at short notice at any time.

This embodiment offers a plurality of technical advantages. It increases the reliability and ease of use of the system by ensuring that critical vehicle functions, such as starting the engine, are able to be executed even under adverse circumstances. Providing a minimum energy supply reduces the risk of the user not being able to access or start the vehicle when the rechargeable battery of the mobile device is empty. This is particularly important in emergency situations in which it is required to start the vehicle quickly. In addition, security is ensured, since authentication still remains necessary and therefore no unauthorized use of the vehicle is possible. This solution combines technical efficiency with practical applicability and represents an innovative response to a common problem when using digital keys.

According to a further preferred embodiment, the data interface apparatus and/or the control and/or evaluation apparatus may be executed in an updateable manner so as to support future security and communication protocols and to integrate enhanced authentication methods and/or charging protocols.

The embodiment described makes provision for the data interface apparatus and/or the control and/or evaluation apparatus to be able to be executed in an updateable manner. This means that both components are designed in such a way that they are able to be adapted to future security, communication, and authentication developments by way of software or firmware updates. This makes the arrangement future-proof and flexible for new technological requirements.

The updateability of the data interface apparatus could ensure that new communication protocols, such as improved standards for wireless data transmission or more efficient charging protocols, are able to be integrated. This could be carried out via the Qi standard, for example the Qi2 standard or higher, in particular in the course of the transfer of the Magnetic Power Profile (MPP) and/or the Extended Power Profile (EPP).

Such updates could not only add new functions, but also close security gaps that could arise as a result of new cybersecurity threats.

The control and/or evaluation apparatus could also be executed in an updateable manner so as to implement improved authentication methods or more complex security protocols. By way of example, future enhancements could support technologies such as biometric authentication, such as, for example, fingerprint and/or face recognition, and/or decentralized key management, in particular cloud platforms, for example. The integration of new algorithms for encryption and/or key exchange methods could also be made possible by updates.

Technically, the updateability could be ensured by a modular software architecture in which the core functions are executed separately from the updateable components. A secure boot loader could be integrated in the hardware to accept updates only from authorized sources, which prevents unauthorized manipulation. In addition, redundant memory areas could be used, which are able to restore the previous state in the event of a faulty update.

The technical advantages of this embodiment are manifold. The updateability ensures that the arrangement remains at the technological forefront over its entire life cycle. This not only contributes to security and functionality, but also reduces the need to replace hardware prematurely, which saves on costs and resources. Furthermore, the flexibility of the data interface apparatus and the control and/or evaluation apparatus allows continuous adaptation to the needs of the users as well as to regulatory or technological changes. This embodiment makes the arrangement a durable, secure and adaptable solution.

According to a further preferred embodiment, the data interface apparatus and the control and/or evaluation apparatus may be designed to implement security-relevant functions, wherein at least encryption and/or key management may be provided to protect the transmitted digital key.

The embodiment described makes provision for the data interface apparatus and/or the control and/or evaluation apparatus to be able to be designed to implement security-relevant functions. In particular, encryption and/or key management may be provided to effectively protect the transferred digital key from unauthorized access or manipulation. These security-related functions are central to ensuring the integrity and confidentiality of communication between the mobile device and the vehicle.

The data interface apparatus may be designed in such a way that it in particular supports modern encryption standards such as AES (Advanced Encryption Standard) and/or RSA (Rivest-Shamir-Adleman). These encryption methods could be used to secure the authentication data during transmission, such that only the control and/or evaluation apparatus of the vehicle is able to decrypt and/or validate the data. To ensure even greater security, additional security protocols such as TLS (Transport Layer Security) and/or DTLS (Datagram Transport Layer Security) could be used, which secure all communication between the devices.

Key management could also be an integral part of this embodiment. A centralized or decentralized approach could be followed in this case. In the case of centralized management, the keys could be securely stored in a hardware security module (HSM) or a trusted platform module (TPM) in the vehicle and/or in the mobile device. Decentralized management could be based on cloud platform technologies, in which key distribution and verification is carried out, for example, over a network of nodes, which makes manipulation virtually impossible.

The control and/or evaluation apparatus could furthermore include mechanisms for detecting security breaches, such as intrusion detection systems (IDSs), which monitor suspicious activity and, in the event of an attack, take measures such as blocking power transmission and/or deactivating certain functions. Furthermore, the apparatus could be designed to regularly renew and/or update the digital key to further reduce the risk of breaches.

This embodiment offers significant technical advantages. Encryption and key management increase the security of the entire arrangement by ensuring that only authorized devices have access to critical functions such as energy transmission or vehicle authentication. This considerably reduces the risk of misuse, for example, as a result of theft or unauthorized copying of the digital key. Furthermore, the flexible and scalable security mechanisms contribute to the solution being able to adapt to future threats or technology requirements. This combination of measures makes the embodiment described a robust and secure basis for modern wireless energy transmission and authentication systems.

According to a further preferred embodiment, a frequency or time-division multiplexing method may be provided to carry out the energy transmission and the data transmission for the authentication without interference.

The embodiment described makes provision for a frequency or time-division multiplexing method to carry out the energy transmission and the data transmission for the authentication without interference. These methods allow the two transmission modes, wireless energy transmission and communication for authentication, to be implemented in parallel and without mutual influence, as a result of which the efficiency and reliability of the system is able to be considerably increased.

In the case of the frequency-division multiplexing method, energy transmission and data transmission are carried out on different frequency bands. The frequency ranges could be chosen in such a way that they do not overlap, as a result of which interference is avoided. By way of example, energy transmission could be carried out in a lower frequency range, while data communication could take place in a higher range that is less susceptible to interference. One technical implementation could be carried out by using tuned antennas and filter structures that clearly separate the frequencies of the two transmission modes.

Alternatively, a time-division multiplexing method could be used, in which energy transmission and data transmission are carried out in temporally separate intervals. In such a scenario, the energy transfer apparatus would temporarily interrupt energy transmission to perform data transmission for the authentication, and then continue the charging process. This method requires precise synchronization between the vehicle and the mobile device, which is able to be ensured by a control and/or evaluation apparatus.

Technically, these methods could be implemented by specialized control algorithms and signal processors that dynamically coordinate the transmission modes. The control could also be of adaptive design, with the result that the system automatically switches between frequency and time-division multiplexing on the basis of present conditions, such as signal interference or energy requirements, in order to ensure the best performance.

The integration of such a multiplexing method offers a plurality of technical advantages. It enables interference-free parallel use of energy and data transmission, which is of critical importance in particular for security-critical applications such as authentication. Furthermore, it optimizes resource utilization, since both transmission modes are able to be efficiently implemented on the same physical components. This reduces the complexity and space requirement of the energy transfer apparatus. Furthermore, reducing interference contributes to increased reliability and better user experience, since both the charging power and the communication stability are improved.

Overall, this embodiment creates a technically elegant solution for simultaneous energy and data transmission, which is convincing in terms of performance and security and efficiency.

According to a further preferred embodiment, the data interface apparatus and the control and/or evaluation apparatus may support a distributed key exchange method, in particular selected from TLS, DTLS and/or comparable standards, in order to secure the authentication information against unauthorized access.

The embodiment described makes provision for the data interface apparatus and the control and/or evaluation apparatus to be able to support a distributed key exchange method in order to effectively protect the authentication information against unauthorized access. Established security standards such as TLS (Transport Layer Security), DTLS (Datagram Transport Layer Security) and/or comparable protocols may be used. These standards ensure secure transmission of sensitive data by combining encryption, integrity checking, and authentication.

A distributed key exchange method is able to ensure that both the vehicle and the mobile device each only have the parts of the encryption and/or authentication data intended for them. These data are exchanged during communication, but never in a way that allows unauthorized access or misuse. By way of example a Diffie-Hellman key exchange could be used, in which a common secret key is generated without said key ever being directly transferred. Alternatively, asymmetric cryptography methods such as RSA and/or elliptic curves could also be used, in which public and private keys are used for secure communication.

The technical implementation of such a key exchange method could be carried out in the data interface apparatus by specialized security chips or modules that accelerate and secure the encryption and authentication processes using hardware. The control and/or evaluation apparatus could additionally have software components that allow flexible adaptation to new standards or security protocols. The control and/or evaluation apparatus could furthermore include mechanisms for detecting attacks such as replay or man-in-the-middle attacks, as a result of which security is increased further.

The use of TLS and/or DTLS offers additional advantages. They ensure not only the encryption of the data, but also the integrity thereof by ensuring that the transmitted information is not able to be altered during transmission. This is particularly important to ensure that the digital key is not manipulated or intercepted.

The technical and practical relevance of this embodiment lies in increasing the security of the entire arrangement. The use of a distributed key exchange method ensures that only authorized devices gain access to the authentication data and that sensitive information remains protected. In addition, supporting established standards such as TLS and/or DTLS allows high interoperability with existing technologies and ensures long-term adaptability to new security requirements. Overall, this embodiment contributes to the arrangement having a robust, secure and future-proof design.

According to a further preferred embodiment, the energy transfer apparatus may have an interference management apparatus, which may be designed to control both energy transmission and data transmission with low interference by dynamically adapting the transmission frequency, transmission power and/or transmission intervals.

The embodiment described makes provision for the energy transfer apparatus to be equipped with an interference management apparatus. This apparatus is designed to control energy transmission and data transmission with low interference by dynamically adapting the transmission frequency, transmission power and/or transmission intervals. The aim of this function is to minimize interference between transmission modes and with other electronic systems to ensure stable and efficient communication and energy transmission.

The interference management apparatus could be designed in such a way that it continuously monitors the electromagnetic environmental conditions and dynamically adapts the transmission parameters on the basis of this analysis. By way of example, the transmission frequency of the energy transfer apparatus could be shifted to ranges in which there is less external interference. This would be advantageous in particular for applications in complex electromagnetic environments, such as urban areas or vehicles with extensive electronics.

Dynamically adapting the transmission power could be directed to accurately meeting the energy requirement of the mobile device without generating unnecessary electromagnetic radiation. This not only reduces interference, but also improves the efficiency of energy transmission. Similarly, controlling the transmission intervals could contribute to data and energy being transmitted at optimal times, as a result of which the overall utilization of communication and energy transmission channels is optimized.

Technically, the interference management apparatus could be implemented using a combination of sensors, algorithms and control loops. Sensors could detect interference or conflicts in the frequency range, while algorithms calculate the ideal parameters based on this data. The adaptation could be carried out in real time, controlled by software in the control and/or evaluation apparatus of the energy transfer apparatus.

A further aspect of this apparatus could be the use of frequency hopping technologies, in which the transmission frequency changes at regular intervals to reduce the likelihood of interference. Adaptive modulation methods could also be integrated to keep data transmission stable even in environments that are subject to interference.

The technical advantages of this embodiment are considerable. Minimizing interference increases the reliability of energy transmission and authentication, which is of particular importance for security-critical applications. The increase in efficiency by dynamically adapting the transmission parameters results in optimal resource utilization, which improves the energy efficiency of the entire arrangement. In addition, the ability to respond flexibly to changing environmental conditions increases the ease of use and versatility of the energy transfer apparatus. This embodiment is therefore a critical innovation to sustainably improve the performance and reliability of wireless energy and data transmission systems.

According to a further preferred embodiment, the data interface apparatus may be designed to identify whether the mobile device is able to deliver energy to the vehicle, and the control and/or evaluation apparatus may enable the direction of the energy transmission depending on the authentication result such that external energization may be permissible only when authentication is successful.

The embodiment described makes provision for the data interface apparatus to be able to be designed to identify whether the mobile device is able to deliver energy to the vehicle. At the same time, the control and/or evaluation apparatus may enable the direction of the energy transmission depending on the authentication result such that external energization of the vehicle by the mobile device is permissible only when authentication is successful. This functionality serves both the security and the efficiency of the arrangement.

The data interface apparatus could be designed in such a way that it retrieves information about the state of charge and energy transmission capability of the mobile device continuously or as required. This could be carried out by way of protocols that record the rechargeable battery level, the maximum available charging power, and the compatibility with the vehicle. One possible technical implementation would be the use of standardized communication protocols such as the Qi standard, for example the Qi2 standard or higher, in particular in accordance with the Magnetic Power Profile (MPP) and/or Extended Power Profile (EPP).

The control and/or evaluation apparatus performs the task of analyzing this information and deciding whether external energization is enabled. A prerequisite for this is successful authentication of the mobile device by the digital key. Energy transmission from the mobile device to the vehicle is activated only after this check. This security measure ensures that only authorized devices are able to feed energy into the vehicle, as a result of which potential risks such as overloading, malfunction or unauthorized manipulation are avoided.

One technical configuration of this function could make provision for the control and/or evaluation apparatus to integrate directional control logic, which allows or blocks energy transmission in both directions depending on the authentication result. For this purpose, bidirectional power electronics components could be used in the energy transfer apparatus, which are able to control both the flow of energy to the mobile device and the external energization. In addition, security protocols such as encryption or key management could be integrated into the control to prevent unauthorized access.

This embodiment offers a plurality of technical and practical advantages. The possibility of dynamically controlling the energy transmission and managing the direction of the energy transmission extends the functionality of the arrangement. Authentication provides increased security, since it ensures that only authorized devices are able to deliver energy to the vehicle. This is of particular importance in emergencies when the vehicle battery is empty and external energization is required. At the same time, checking the energy transmission capability of the mobile device increases efficiency, since it is ensured that the process is initiated only when sufficient power is available. Overall, this embodiment increases the security, versatility and ease of use of the arrangement and provides an innovative solution for bidirectional energy transmission.

By way of example, the vehicle could be a car, a truck, a bus, a motorcycle or an autonomous vehicle.

The present invention is explained in more detail below with reference to the exemplary embodiments specified in the schematic figures of the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic block diagram of an embodiment of the arrangement according to the invention.

FIG. 2 shows a schematic view of a further embodiment of the arrangement according to the invention.

FIG. 3 shows a schematic flow diagram of an embodiment of a method according to the invention.

FIG. 4 shows a schematic flow diagram of a further embodiment of a method according to the invention.

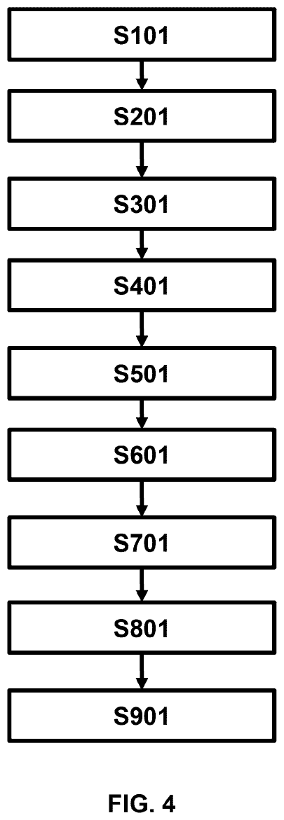

### DETAILED DESCRIPTION OF THE DRAWINGS

If appropriate, the configurations and developments described may be combined with each other as desired.

Further possible configurations, developments and implementations of the invention could also comprise not explicitly mentioned combinations of features of the invention that are described above or hereinafter with regard to the exemplary embodiments.

The accompanying drawings are intended to provide additional understanding of the embodiments of the invention. They illustrate embodiments and are used in combination with the description to explain principles and concepts of the invention.

Other embodiments and many of the advantages mentioned could be apparent in view of the drawings.

The elements of the drawings are not necessarily shown to scale in relation to each other. Identical reference signs denote components that are identical or have a similar effect.

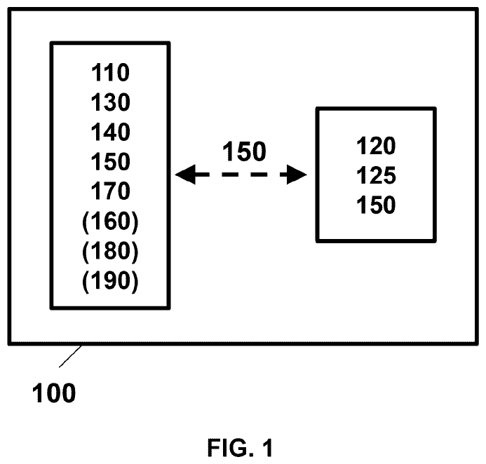

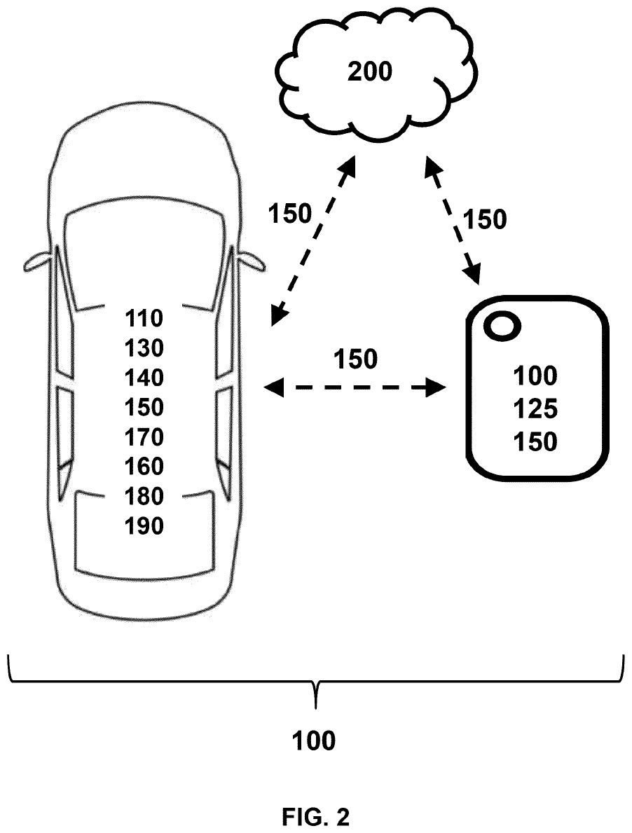

FIG. 1 shows a schematic block diagram of an embodiment of the arrangement 100 according to the invention, and FIG. 2 shows a schematic view of a further embodiment of the arrangement 100 according to the invention. The arrangement 100 for wireless energy transmission and/or authentication between a vehicle 110 and a mobile device 120 comprises the vehicle 110 and an energy transfer apparatus 130, which is arranged in or on the vehicle 110 and is designed to carry out inductive energy transmission with the mobile device 120. The energy transfer apparatus 130 has a data interface apparatus 140 for wireless communication, which is designed to transmit a charging protocol between the energy transfer apparatus 130 and the mobile device 120, and to transfer a digital key 150 for uniquely authenticating the vehicle 110 and/or the mobile device 120. Furthermore, the arrangement 100 comprises a control and/or evaluation apparatus 170, which is designed, after successful authentication by means of the digital key 150, to at least: enable energy transmission between the vehicle 110 and the mobile device 120, and/or enable at least one vehicle function.

The charging protocol can correspond to a Qi standard, in particular the Qi2 standard or higher, specifically above the specifications of the transmission of the Magnetic Power Profile (MPP) and/or Extended Power Profile (EPP) and both the charging control and the transmission of the digital key 150 are carried out via the same data channel. The authentication may comprise a CCC Digital Key as a digital key 150, which is designed in accordance with a standardized vehicle access and/or engine starting method.

The energy transfer apparatus 130 may be formed inside the vehicle 110 as a charging tray in which the mobile device 120 is able to be arranged simultaneously for the authentication by means of the digital key 150 and the charging process. A further wireless charging point 160 may be arranged outside of the vehicle 110, said charging point being designed to allow external energization via the mobile device 120 when the vehicle battery 180 is discharged, wherein an authentication for enabling vehicle access may in particular be simultaneously carried out.

The data interface apparatus 140 and the control and/or evaluation apparatus 170 may be connected to one other in such a way that, in the case of successful authentication by means of the digital key 150, at least one function of the vehicle 110 is enabled. This function may be selected in particular from unlocking the door, starting the engine or enabling energy transmission. Furthermore, the data interface apparatus 140 may be configured for real-time evaluation of the authentication data sent by the mobile device 120 and designed to enable or adapt the subsequent charging process depending on the result of the authentication.

An optimized geometric arrangement of antenna structures 180 in the vehicle 110 may be made possible by integrating the wireless charging and authentication functions in the energy transfer apparatus 130, with the result that interference between these functions may in particular be reduced. When the rechargeable battery 125 of the mobile device 120 is empty, authentication may be made possible by the energy transfer apparatus 130 using a minimum residual energy supply, in particular to ensure that the engine is started inside the vehicle 110.

The data interface apparatus 140 and/or the control and/or evaluation apparatus 170 may be executed in an updateable manner so as to support future security and communication protocols and to integrate enhanced authentication methods and/or charging protocols. Furthermore, the data interface apparatus 140 and the control and/or evaluation apparatus 170 may be designed to implement security-relevant functions, wherein at least encryption and/or key management may be provided to protect the transmitted digital key 150.

A frequency or time-division multiplexing method may be provided to carry out the energy transmission and the data transmission for the authentication without interference. The data interface apparatus 140 and the control and/or evaluation apparatus 170 may support a distributed key exchange method, in particular selected from TLS, DTLS and/or comparable standards, in order to secure the authentication information against unauthorized access.

The energy transfer apparatus 130 may have an interference management apparatus 190, which may be designed to control both energy transmission and data transmission with low interference by dynamically adapting the transmission frequency, transmission power or transmission intervals. In addition, the data interface apparatus 140 may be designed to identify whether the mobile device 120 is able to deliver energy to the vehicle 110, wherein the control and/or evaluation apparatus 170 enables the direction of the energy transmission depending on the authentication result such that external energization may be permissible only when authentication is successful.

According to the present invention, additional functions that enhance and optimize the arrangement 100 and the associated method may be implemented by integrating a cloud platform 200. Authentication data of the digital key 150 is able to be securely stored and managed via the cloud 200, as a result of which decentralized access control is made possible. In addition, the cloud 200 is able to be used as an interface for software updates of the data interface apparatus 140 and/or the control and/or evaluation apparatus 170 in order to integrate new security and communication protocols as well as enhanced energy transmission and/or authentication methods. Furthermore, the charging history and/or operating parameters of the arrangement 100 could be stored and/or analyzed in the cloud 200 to enable predictive maintenance, energy management optimization and/or individual user adaptations. Furthermore, the cloud 200 could be used as a central hub to synchronize a plurality of vehicles 110 and/or mobile devices 120 and ensure uniform management of the digital key 150 across various mobile devices 120 and/or vehicles 110. Such functions increase the flexibility and scalability of the arrangement 100 and ensure a secure and future-proof application.

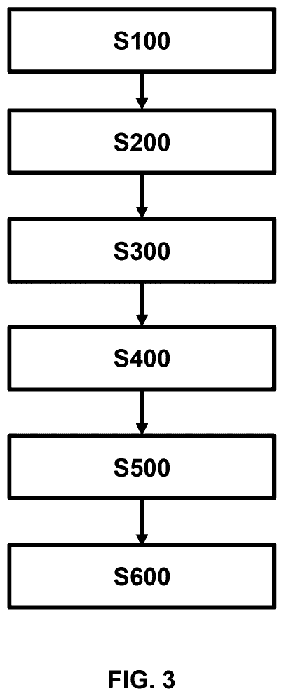

FIG. 3 shows a schematic flow diagram of an embodiment of a method according to the invention. The method for wireless energy transmission and authentication between a vehicle 110 and a mobile device 120, using an energy transfer apparatus 130, which has a data interface apparatus 140 for wireless communication, and is connected to a control and/or evaluation apparatus 170, comprises the following steps:
S100: providing the vehicle 110 and arranging the energy transfer apparatus 130 in or on the vehicle 110,
S200: activating the data interface apparatus 140, which is designed to exchange a charging protocol with the mobile device 120,
S300: establishing inductive energy transmission and/or data transmission between the energy transfer apparatus 130 and the mobile device 120,
S400: transferring a digital key 150 between the vehicle 110 and the mobile device 120 via the data interface apparatus 140,
S500: authenticating the vehicle 110 and/or the mobile device 120 with the aid of the digital key 150, and
S600: enabling energy transmission between the vehicle 110 and the mobile device 120, and/or at least one vehicle function, in particular, for example, starting the engine and/or unlocking the door, by means of the control and/or evaluation apparatus 170 after successful authentication.

FIG. 3 shows a schematic flow diagram of an embodiment of a method according to the invention. The method for wireless energy transmission and/or authentication between a vehicle 110 and a mobile device 120, using an energy transfer apparatus 130, which has a data interface apparatus 140 for wireless communication, and is connected to a control and/or evaluation apparatus 170, comprises the following steps:
S101: The user puts the vehicle 110 at a suitable location and places the mobile device 120 on the charging tray 130 inside the vehicle 110. The energy transfer apparatus 130 is integrated into the charging tray 130, for example, under the surface for receiving the mobile device 120, in order to ensure optimal positioning and secure placement.
S201: The user activates the data interface apparatus 140 by placing the mobile device 120 onto the charging tray 130. Activation causes the data interface apparatus 140 to begin to exchange a charging protocol in accordance with the Qi2 standard. Both the Magnetic Power Profiles (MPPs) and Extended Power Profiles (EPPs) are transmitted via the same data channel to allow the charging control and the transmission of the digital key 150.
S301: In particular, inductive energy transmission is established between the energy transfer apparatus 130 and the mobile device 120. The antenna structures 180 integrated in the charging tray 130 are electromagnetically coupled to the corresponding coils in the mobile device 120 in order to wirelessly transmit electrical energy.
S401: The data interface apparatus 140 transfers the digital key 150 from the vehicle 110 to the mobile device 120 via the Magnetic Power Profile (MPP) and/or the Extended Power Profile (EPP). This digital key 150 is used to uniquely authenticate the vehicle 110 and the mobile device 120 in accordance with the CCC Digital Key standard.
S501: The control and/or evaluation apparatus 170 analyzes the digital key 150 and authenticates the mobile device 120 and the vehicle 110. In this case, the control and/or evaluation apparatus 170 checks the validity of the digital key 150 by comparison with stored vehicle data.
S601: After successful authentication, the control and/or evaluation apparatus 170 enables energy transmission between the vehicle 110 and the mobile device 120 and/or a vehicle function. This allows the mobile device 120 to continue the charging process or to draw energy from the vehicle 110.
S701: The data interface apparatus 140 evaluates the authentication data of the mobile device 120 in real time. Depending on the result of the authentication, the control and/or evaluation apparatus 170 adapts the charging process and/or a vehicle function by, for example, varying the charging power or optimizing the charging schedule.
S801: If the rechargeable battery 125 of the mobile device 120 is empty, the data interface apparatus 140 identifies that the mobile device 120 is able to deliver energy to the vehicle 110. After successful authentication via the digital key 150, the control and/or evaluation apparatus 170 enables the direction of the energy transmission such that external energization of the vehicle 110 is allowed.
S901: The interference management apparatus 190 continuously monitors the electromagnetic environmental conditions and dynamically adapts the transmission frequency, transmission power and transmission intervals. This minimizes interference between energy transmission and/or data communication, as a result of which stable and efficient functioning of the arrangement 100 is ensured.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 Arrangement
110 Vehicle
120 Mobile device
125 Rechargeable battery
130 Energy transfer apparatus
140 Data interface apparatus
150 Digital key
160 Charging point
170 Control and/or evaluation apparatus
180 Antenna structures
190 Interference management apparatus
200 Cloud
S100 Method step
S200 Method step
S300 Method step
S400 Method step
S500 Method step
S600 Method step
S101 Method step
S201 Method step
S301 Method step
S401 Method step
S501 Method step
S601 Method step
S701 Method step
S801 Method step
S901 Method step

What is claimed is:

1. An arrangement for wireless energy transmission or authentication between a vehicle and a mobile device, the arrangement comprising:
the vehicle;
an energy transfer apparatus, which is arranged in or on the vehicle and is configured to carry out inductive energy transmission with the mobile device;
wherein the energy transfer apparatus has a data interface apparatus for wireless communication, which is configured to transmit a charging protocol between the energy transfer apparatus and the mobile device, and transfer a digital key for uniquely authenticating the vehicle or the mobile device; and
a control or evaluation apparatus, which is configured, after successful authentication by the digital key, to enable energy transmission between the vehicle and the mobile device or enable at least one vehicle function.

2. The arrangement according to claim 1, wherein the charging protocol corresponds to a Qi2 standard or higher, and the charging control and the transmission of the digital key are carried out via a same data channel.

3. The arrangement according to claim 1, wherein the authentication comprises a CCC Digital Key as the digital key, which is configured in accordance with a standardized vehicle access method or a standardized engine starting method.

4. The arrangement according to claim 2, wherein the authentication comprises a CCC Digital Key as the digital key, which is configured in accordance with a standardized vehicle access method or a standardized engine starting method.

5. The arrangement according to claim 1, wherein the energy transfer apparatus is formed inside the vehicle as a charging tray in which the mobile device is able to be arranged simultaneously for the authentication by the digital key and the charging process.

6. The arrangement according to claim 2, wherein the energy transfer apparatus is formed inside the vehicle as a charging tray in which the mobile device is able to be arranged simultaneously for the authentication by the digital key and the charging process.

7. The arrangement according to claim 3, wherein the energy transfer apparatus is formed inside the vehicle as a charging tray in which the mobile device is able to be arranged simultaneously for the authentication by the digital key and the charging process.

8. The arrangement according to claim 1, wherein a further wireless charging point is arranged outside of the vehicle and is configured to allow external energization via the mobile device when a vehicle battery is discharged, wherein an authentication for enabling vehicle access is simultaneously carried out.

9. The arrangement according to claim 2, wherein a further wireless charging point is arranged outside of the vehicle and is configured to allow external energization via the mobile device when a vehicle battery is discharged, wherein an authentication for enabling vehicle access is simultaneously carried out.

10. The arrangement according to claim 3, wherein a further wireless charging point is arranged outside of the vehicle and is configured to allow external energization via the mobile device when a vehicle battery is discharged, wherein an authentication for enabling vehicle access is simultaneously carried out.

11. The arrangement according to claim 1, wherein the data interface apparatus and the control or evaluation apparatus are connected to each other such that, for a successful authentication by the digital key, at least one vehicle function of the vehicle is enabled, which is selected from:
unlocking the door,
starting the engine, and
enabling energy transmission.

12. The arrangement according to claim 2, wherein the data interface apparatus and the control or evaluation apparatus are connected to each other such that, for a successful authentication by the digital key, at least one vehicle function of the vehicle is enabled, which is selected from:
unlocking the door,
starting the engine, and
enabling energy transmission.

13. The arrangement according to claim 3, wherein the data interface apparatus and the control or evaluation apparatus are connected to each other such that, for a successful authentication by the digital key, at least one vehicle function of the vehicle is enabled, which is selected from:
unlocking the door,
starting the engine, and
enabling energy transmission.

14. The arrangement according to claim 1, wherein, when the rechargeable battery of the mobile device is empty, authentication is made possible by the energy transfer apparatus using a minimum residual energy supply to ensure that the engine is started inside the vehicle.

15. The arrangement according to claim 2, wherein, when the rechargeable battery of the mobile device is empty, authentication is made possible by the energy transfer apparatus using a minimum residual energy supply to ensure that the engine is started inside the vehicle.

16. The arrangement according to claim 3, wherein, when the rechargeable battery of the mobile device is empty, authentication is made possible by the energy transfer apparatus using a minimum residual energy supply to ensure that the engine is started inside the vehicle.

17. The arrangement according to claim 1, wherein a frequency-division multiplexing method or time-division multiplexing method is provided to carry out the energy transmission and the data transmission for the authentication without interference.

18. The arrangement according claim 1, wherein the data interface apparatus is configured to identify whether the mobile device is able to deliver energy to the vehicle, and wherein the control or evaluation apparatus enables direction of the energy transmission depending on an authentication result such that external energization is permissible only when the authentication is successful.

19. The arrangement according claim 2, wherein the data interface apparatus is configured to identify whether the mobile device is able to deliver energy to the vehicle, and wherein the control or evaluation apparatus enables direction of the energy transmission depending on an authentication result such that external energization is permissible only when the authentication is successful.

20. A method for wireless energy transmission or authentication between a vehicle and a mobile device, using an energy transfer apparatus, which has a data interface apparatus for wireless communication and is connected to a control or evaluation apparatus, the method comprising:
providing the vehicle and arranging the energy transfer apparatus in or on the vehicle;
activating the data interface apparatus, which is configured to exchange a charging protocol with the mobile device;
establishing inductive energy transmission or data transmission between the energy transfer apparatus and the mobile device;
transferring a digital key between the vehicle and the mobile device via the data interface apparatus;
authenticating the vehicle or the mobile device with the digital key; and
enabling energy transmission between the vehicle and the mobile device, or at least one vehicle function by the control or evaluation apparatus after successful authentication.
